(19) United States
(12) Patent Application Publication
(10) Pub. No.: US 2011/0254185 A1
(43) Pub. Date: Oct. 20, 2011

(54) MOULD SEGMENTS WITH INDEXING MEANS AND METHOD OF ALIGNING MOULD SEGMENTS

(76) Inventors: Khong Fah Liew, Kuala Lampur (MY); Yoke Thye Low, Kuala Lampur (MY)

(21) Appl. No.: 13/061,522

(22) PCT Filed: Sep. 3, 2009
(86) PCT No.: PCT/MY2009/000134

§ 371 Date: Jul. 7, 2011

(30) Foreign Application Priority Data
Sep. 3, 2008 (MY) P120083397

(51) Int. Cl. B29C 33/30; B22C 9/28

(52) U.S. Cl. 264/40.5; 249/56

(57) ABSTRACT

This invention relates generally to a mould segment used in the production of premoulded and precured tyre thread in a flat moulding process wherein the mould segment (1) is provided with an indexing means to align adjacent mould segments to avoid discontinuity in thread pattern. In this invention the indexing means is provided on the opposing transverse edges (14, 15) of the mould segment (1). Various embodiments of the indexing means are described. The invention also relates to a method of aligning mould segments in a mould matrix using indexing means on the opposing transverse edges (14, 15) of the mould segments.

### BACKGROUND OF INVENTION

1. Field of Invention

This invention relates generally to a mould segment used in the production of premoulded and precured tyre thread in a flat moulding process wherein the mould segment is provided with an indexing means to align adjacent mould segments so as to eliminate displacement or aberration in the premoulded and procured tyre thread pattern. The invention also relates to a method of aligning mould segments in a mould matrix using indexing means on the opposing transverse edges of the mould segments.

2. Discussion on Related Art

In the production of premoulded and precured tyre thread, a flat press is generally used. The flat press generally has an upper platen and a lower platen (30), both made of heat conducting materials such as steel or aluminium. Referring to FIG. 1, during setting up stage for the production of premoulded and precured tyre thread, a plurality of mould segments with repeating thread pattern are placed side by side one another to form a mould matrix that sits on the lower platen (30) of a flat press in a space defined between two guide bars (32). The number of mould segments required to form the matrix depends on the length of premoulded and precured tyre thread needed to be able to securely wrap the tyre thread around the tyre carcass to be retreated such that two ends of the tyre thread contact each other in an acceptable manner. Once the mould segments of a mould matrix are loaded in place, a clamp bar (33) is placed longitudinally across the shoulders (24) of the plurality of mould segments and the guide bar (32). Each clamp bar (33) rests on a guide bar (32) and the shoulders (24) of a plurality of mould segments. A removable fastener (35) removably secures each of the guide bar (32) and clamp bars (33) to the lower platen (30) of the flat press. The clamp bars (33) in turn secure the mould segments to the lower platen (30) of the flat press.

The thread pattern is defined by the cavity of the mould segments. In a changeover to the production of another thread pattern, the mould segments on the lower platen (30) are removed and replaced with mould segments defining other thread patterns.

To begin the moulding process, a rubber blank is placed on the cavities (11) of the mould segments and between the mould walls (12, 13) of the mould segments. The upper platen then moved vertically downwards and presses on the rubber blank, imprinting a thread pattern onto the rubber blank in the curing and vulcanization process. The moulding process requires the upper platen and the lower platen (30) of the flat press to be heated and maintained at a very high temperature, typically in excess of 300° F. The thermal expansion of the guide bars (32), the clamp bars (33) and the mould segments requires that expansion gaps (41, 42, 43, 44) be provided for between the mould walls of each of the mould segments and the walls of the guide bars (32), and that of the clamp bars (33) proximate to the mould walls.

There must be sufficient allowance for expansion gaps (41, 42, 43, 44). This is to ensure that there is no compression force exerted on the edges of the mould segments as a result of thermal expansion of the mould segments, guide bars (32) and clamp bars (33). The compression force may cause distortion to the mould cavity (11). Further, during the changeover to the moulding of another tyre thread pattern, the mould segments can be readily removed if the expansion gaps allowance is sufficient. Otherwise, thermal expansion may result in interference fit between the edges of the mould walls of the mould segments and the guide bars (32), resulting in the operator of the flat press having to wait for the temperature to drop before the mould segments could be removed and replaced with other mould segments defining other thread patterns in a change over set up procedure.

Ideally the mould segments should be arranged to sit on the lower platen (30) so that the expansion gap (say 41) is fixed and constant between the edges of the mould walls of each of the plurality of mould segments and the guide bars (32). In practice, it is time consuming and very difficult for the operator loading and aligning the mould segments in a change over procedure to ensure that the expansion gaps (41, 42, 43, 44) are fixed and constant for all mould segments in the mould matrix. In addition in the course of the moulding process, there could be relative movements of the mould segments caused by pressing action of the upper platen as well as during the process of removing the premoulded and precured tyre thread from the lower platen (30). If the expansion gaps are not fixed and uniform, the premoulded and precured tyre thread will exhibit displaced or distorted thread pattern as shown encircled in sections A and B in FIG. 2, which is an abridged view of premoulded and procured tyre thread from three mould segments. The dotted lines in FIG. 3 merely show the boundary of each of the three mould segments.

It is therefore desirable to provide an indexing means for the mould segments so as to eliminate misalignment between adjacent mould segments to avoid displaced or distorted thread pattern in a premoulded and precured tyre thread.

In one prior art, as shown in FIG. 2, the base of each mould segment is provided with a keyway (71). A key guide that matches the dimension of the keyway (71) is provided on the lower platen (30) of the moulding machine so that when the mould segments are loaded onto the lower platen (30), the keyway (71) fits matingly and rest on the guide. In this way, the mould segments could be aligned to one another. However, if a mould segment is not placed with the keyway (71) resting properly on the key guide, the pressing force from the upper platen of the flat press may cause the mould segment to break. There are several situations in which such breakage may happen. The first situation is caused by human error of the operator in not fitting the keyway (71) properly on the key guide during loading of the mould segments in a change over set up procedure. The second situation is when waste rubber crumb left at the intersection edge between the key guide and the lower platen (30) from the preceding moulding operation obstructed the keyway (71) of the mould segment from sitting properly onto the key guide. The third situation is the dislocation of a mould segment during the removal of the premoulded and precured tyre thread after a moulding process.

### SUMMARY OF INVENTION

In order to overcome the shortcoming of a mould matrix without indexing means or a mould matrix with indexing means of the prior art, the invention provides for an indexing means on the opposing transverse edges of each mould segment.

In one embodiment, the indexing means for each of the opposing transverse edges of the mould segment comprises at least one combination of a recess and a pin. The pin has a portion inserted or insertable into the recess and has the remaining portion inserted or insertable into a recess on the other opposing transverse edge of an adjacent mould segment of the mould matrix.

In another embodiment, the indexing means for each of the opposing transverse edges of the mould segment comprises at least one combination of a recess, a bushing inserted or insertable into the recess and a pin with a portion inserted or insertable into the opening of the bushing. The complimentary indexing means on the other opposing transverse edge of an adjacent mould segment for each of the combination is a recess and a bushing, with the bushing inserted or insertable into the recess. The remaining portion of the pin is slidably insertable into the opening of the bushing on this other opposing transverse edge.

In yet another embodiment, the indexing means on the first opposing transverse edge comprises at least one combination of a recess and a pin, the pin having a bigger portion and a smaller portion, with the bigger portion inserted into the recess. The indexing means on the second opposing transverse edge comprises at least one combination of a recess and a bushing inserted into the recess. For each combination of the indexing means on the first opposing transverse edge, the complimentary indexing means on the second opposing transverse edge of an adjacent mould segment of the mould matrix is a recess and a bushing inserted or insertable into the recess and with the smaller portion of the pin of the indexing means slidably insertable into the opening of the bushing. For each combination of the indexing means on the second opposing transverse edge, the complimentary indexing means on the first opposing transverse edge of an adjacent mould segment of the mould matrix is a recess and a pin having a bigger portion and a smaller portion with the bigger portion inserted or insertable into the recess on the second opposing transverse edge of the adjacent mould segment and the smaller portion slidably insertable into the opening of the bushing.

In yet another embodiment the indexing means on each of the opposing transverse edges comprises either at least one combination of a recess and a bushing inserted or insertable into the recess, or at least one combination of a recess and a pin having a bigger portion and a smaller portion, with the bigger portion inserted or insertable into the recess. In the former case, for each combination, the complimentary indexing means on the opposing transverse edge of either adjacent mould segment in the mould matrix is a recess and a pin having a bigger portion and a smaller portion with the bigger portion inserted or inseratble into the recess and the smaller portion slidably insertable into the opening of the bushing. In the latter case, for each combination, the complimentary indexing means on the opposing transverse edge of either adjacent mould segment in the mould matrix is a recess and a bushing inserted or insertable into the recess with the smaller portion of the pin slidably insertable into the opening of the bushing.

In yet another embodiment, the indexing means on each of the opposing transverse edges of the mould segment comprises at least one protrusion and/or at least one recess, wherein when the indexing means is a protrusion, the complimentary indexing means on the other opposing edge of an adjacent mould segment of a mould matrix is a recess, with the protrusion slidably insertable into the recess and wherein when the indexing means is a recess, the complimentary indexing means on the other opposing edge of an adjacent mould segment is a protrusion slidably insertable into the recess on the adjacent mould segment. In this embodiment the protrusion is an integral part of the mould segment.

The invention also relates to a method of aligning mould segments in a mould matrix using indexing means on the opposing transverse edges of the mould segments.

### BRIEF DESCRIPTION OF THE DRAWINGS

The drawings constitute part of this specification and include preferred embodiments of the invention. In the appended drawings:

FIG. 1 shows the set up of a mould segment for the production of premoulded and precured tyre thread on a flat press.

FIG. 2 shows a section of the premoulded and procured tyre corresponding to three mould segments when the mould segments are not properly aligned.

FIG. 3 shows a mould segment of prior art with a keyway on the base for indexing purpose.

FIG. 4 shows an embodiment of the mould segment of this invention having pin and recess as the indexing means.

FIG. 5 shows a cross sectional view cut across the pins and recess of three adjacent mould segments and as viewed from mould cavity towards mould wall.

FIG. 6 shows another embodiment of the mould segment of this invention having, recess, bushings and pin as the indexing means.

FIG. 7 shows yet another embodiment of the mould segment of this invention having recess, bushing and pin with two portions as the indexing means.

FIG. 8 shows another embodiment of the mould segment of this invention based on adaptation of the embodiment in FIG. 7.

FIG. 9 shows yet another embodiment of the mould segment of this invention having recess and protrusion which is an integral part of the mould segment as the indexing means.

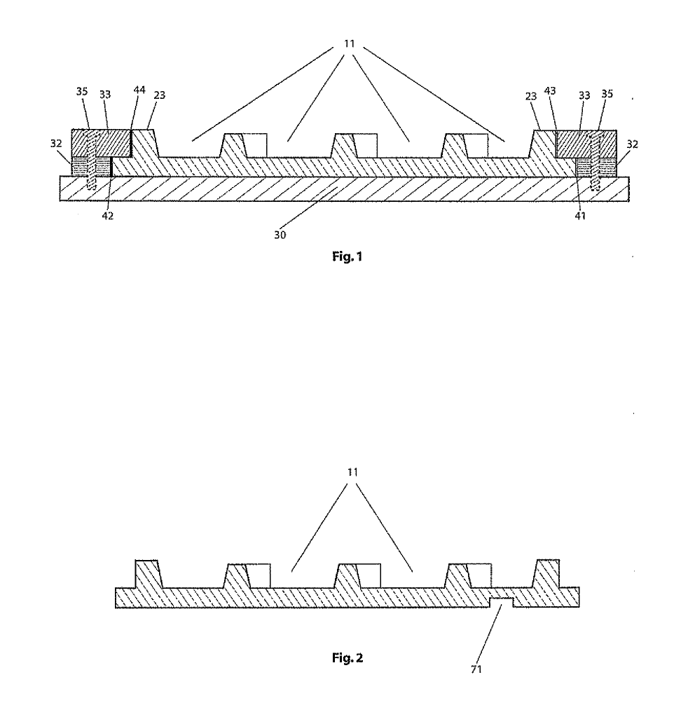

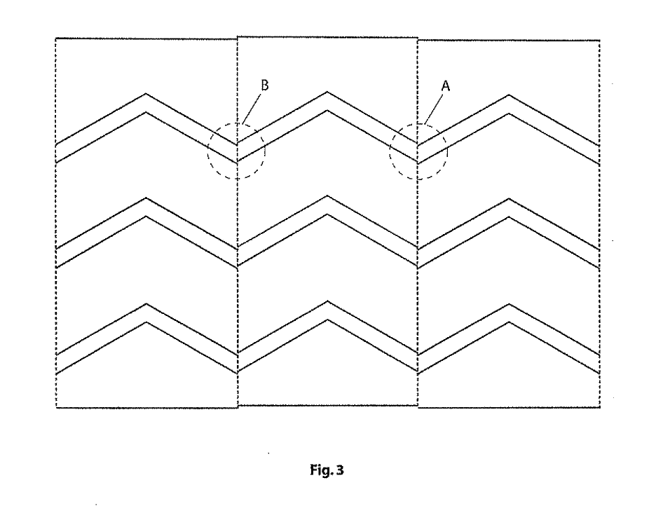

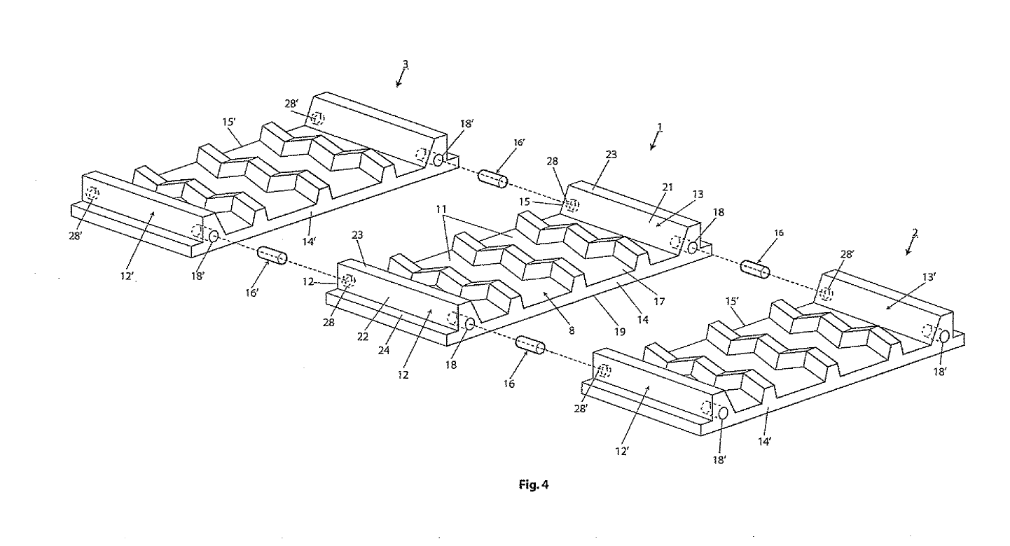

### DETAILED DESCRIPTION OF THE INVENTION

A detailed description of preferred embodiments of the invention is disclosed herein. Hereafter, identical parts or components of the figures representing different embodiments of the invention will be designated by the same reference numerals or the same reference numerals with a prime (′). For instance, 16 and 16′ designate the same part on different mould segments. Similarly 18 and 18′ are the same parts on different mould segments and so on. The prime (′) is added to the reference numerals merely to facilitate the description and understanding of the invention.

FIG. 4 shows a mould segment (1) used in the production of premoulded and precured tyre thread of this invention. The mould segment (1) comprises a base (8), a first and a second opposing mould walls (12, 13) at each end of the base (8), a first and second opposing transverse edges (14, 15), a mould cavity (11) between the mould walls (12, 13) and an indexing means on the first and second opposing transverse edges (14 and 15) for alignment of the mould segment (1) to the adjacent mount segments (2 and 3).

The base (8) has a base back (19), a base front (17) and transverse edges forming part of the first and second opposing transverse edges (14 and 15) of the mould segment (1).

The first and a second opposing mould walls (12, 13) are located at the respective ends of the base (8) and rising from the base front (17). Each opposing mould walls (12, 13) has an inner surface (21), an outer surface (22), a contact surface (23), a shoulder (24) and transverse edges forming part of the first and second transverse edges (14 and 15) of the mould segment (1).

The mould cavity (11) is located on the base front (17) and between the opposing mould walls (12, 13). The mould cavity (11) defines the thread pattern of the premoulded and precured tyre thread.

The material used in the manufacturing of the mould segments is generally aluminium because of its workability. Preferably, the mould cavity (11), the opposing mould walls (12, 13) and the base (8) are cast as an integral unit.

In moulding operation, a plurality of mould segments is secured to the lower platen (30) of the flat press with the use of clamp bars (33) which clamp the shoulders (24) of the first and second opposing mould walls (12, 13) of the plurality of mould segments and the guide bars (32) to the lower platen (30) of the flat press. A removable fastener (35) removably secures each of the guide bars (32) and clamp bars (33) to the lower platen (30) of the flat press. A plurality of such mould segments when placed adjacent to one another forms a mould matrix on the flat press.

In one embodiment, the indexing means on the first opposing transverse edge (14) comprises at least one combination of a recess (18) and a pin (16) with the pin (16) having a portion inserted or insertable, preferably with interference fit, into the recess (18) and with the remaining portion slidably insertable, preferably with clearance fit, into a recess (28′) on the second opposing transverse edge (15′) of an adjacent mould segment (2) of the mould matrix. The recess (28′) on mould segment (2) represents the complimentary indexing means on the adjacent mould segment (2) for the first opposing transverse edge (14).

The indexing means on the second opposing transverse edge (15) is a recess (28). The corresponding complimentary indexing means on the first opposing transverse edge (14′) of an adjacent mould segment (3) comprises a combination of a recess (18′) and a pin (16′) with a portion of the pin (16′) inserted or insertable, preferably with interference fit, into the recess (18′). During setting up of the mould matrix on the flat press, the remaining portion of the pin (16′) is slidably insetable, preferably with clearance fit, into the recess (28) on the second opposing transverse edge (15) of the mould segment (1).

The cross-sectional profile of the recess (18 or 28) and the pin (16 or 16′) should be the same. For instance, if the cross-sectional profile of the pin (16) is triangular or square in shape, the corresponding cross-sectional profile of the recess (18) should be triangular or square in shape respectively. The same applies to the recess (28) and the pin (16′). Preferably, for ease of machining operation, the cross sectional profile of the recess (18, 28) and the pin (16, 16′) should be circular. The pin (16) is preferably beveled or chamfered or having a conical frustum shape at the end to be slidably insertable into the recess (18′) to facilitate the easy indexing between mould segments, in this case between mould segment (1) and (2).

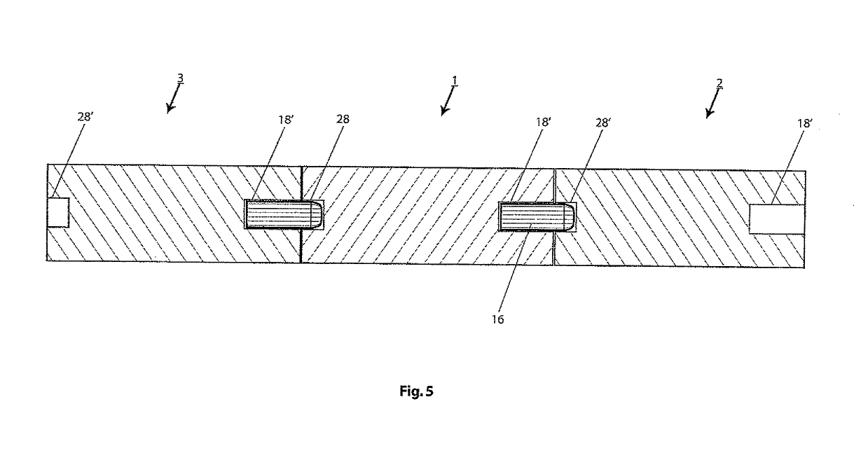

The recess (18) on the first opposing transverse edge (14) could be of the same depth as that of the second opposing transverse edge (15) but preferably the recess (18) has a longer depth than the recess (28) as shown in FIG. 5. The pin (16) is preferably pre-inserted into the recess (18) with a longer depth to help identify the orientation of the thread pattern so as to ensure that the mould segments are loaded and set up on the lower platen (30) of the flat press with repeating thread pattern of every mould segments of the mould matrix oriented in the same direction i.e. the first opposing mould walls of every mould segment must be on the same side and vice versa.

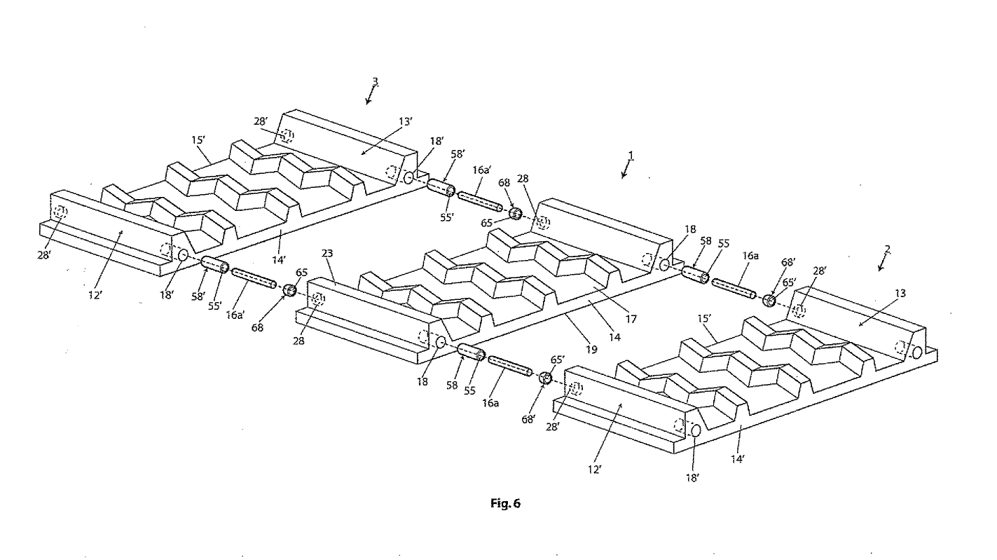

FIG. 6 shows another embodiment of mould segment (1) of the present invention wherein the indexing means on the first opposing transverse edge (14) of the mould segment (1) comprises at least one combination of a recess (18), a bushing (58) and a pin (16a). The bushing (58) is inserted or insertable, preferably with interference fit, into the recess (18) and the pin (16a) has a portion inserted or insertable, preferably with interference fit, into the opening (55) of the bushing (58). The complimentary indexing means on the second opposing transverse edge (15′) of an adjacent mould segment (2), for each combination of indexing means on the first opposing transverse edge (14) of the mould segment (1), comprises a recess (28′) and a bushing (68′) inserted or insertable, preferably with interference fit, into the recess (28′). During setting up of the mould matrix on the flat press, the remaining portion of the pin (16) is slidably insertable, preferably with clearance fit, into the opening (65′) of the bushing (68′) of the recess (28′) on the second opposing transverse edge (15) of the mould segment (2).

The indexing means on the second opposing transverse edge (15) comprises a recess (28) and a bushing (68) for each combination of a complimentary indexing means on the first opposing transverse edge (14′) of an adjacent mould segment (3). The bushing (68) is inserted or insertable, preferably with interference fit, into the recess (28). The complimentary indexing means comprises at least one combination of a recess (181a bushing (58′) and a pin (16a′). The bushing (58′) is inserted or insertable, preferably interference fit, into the recess (18′). The pin (16a′) has a portion inserted or insertable, preferably with interference fit, into the opening (55′) of the bushing (58′) with the remaining portion slidably insertable into the opening (65) of the bushing (68).

The cross-sectional profile of the recess (18 or 28) and the bushing (58, 68) should be the same. Similarly, the cross-sectional profile of the opening (55) of the bushing (58) and the pin (16a) should be the same to enable the pin (16a) to be insertable into the opening (55) of the bushing (58). Preferably, for ease of manufacturing in a machining operation and pre-moulding set up on the flat press, the cross sectional profile of the recess (18 or 28) and the pin (16a) are preferably circular and the cross sectional profile of the bushing (58 or 68) is preferably cylindrical tubular in shape. The pin (16a) is preferably beveled or chamfered or having a conical frustum shape at the free end to facilitate the easy indexing between mould segments, in this case mould segment (1) and (2).

The recess (18) on the first opposing transverse edge (14) could be of the same depth as that of the second opposing transverse edge (15) but preferably the recess (18) has a longer depth than the recess (28). The length of the bushing (58) is substantially the same as the depth of the recess (18). Similarly, the length of the bushing (68) is substantially the same as the depth of the recess (28). The length of the pin (16a) is substantially equal to the sum of the lengths of the bushing (58) and (68′ or 68). As described earlier, the pin (16a) is preferably pre-inserted into the recess (18). This will help the operator loading and setting up the mould segments on a flat press identify the orientation of the thread pattern so that repeating thread pattern oriented in the same direction for every mould segments of the mould matrix i.e. the first opposing mould walls of every mould segment must be on the same side.

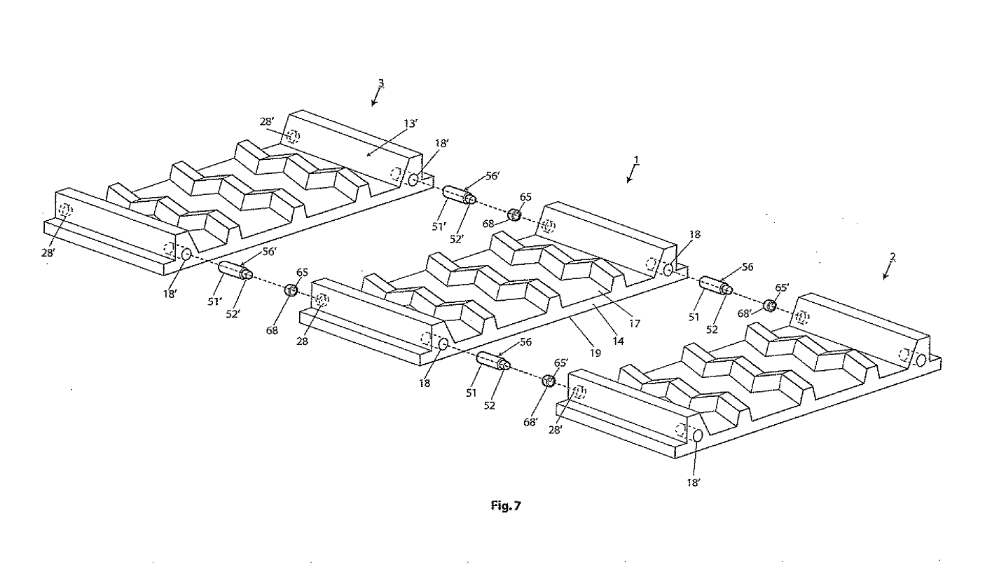

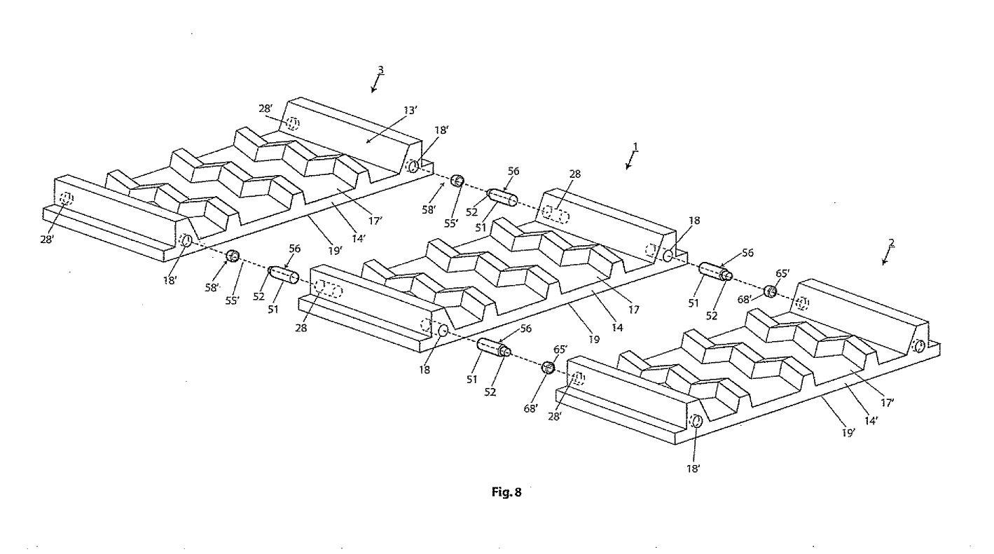

FIG. 7 shows yet another embodiment of the mould segment (1) of this invention wherein the indexing means on the first opposing transverse edge (14) comprises at least one combination of a recess (18) and a pin (56). The pin (56) has a bigger portion (51) and a smaller portion (52), with the bigger portion (51) inserted or insertable, preferably with interference fit, into the recess (18) and the smaller portion (52) slidably insertable into the opening (65′) of the bushing (68′) of a complimentary indexing means on the second opposing transverse edge (15′) of an adjacent mould segment (2). The complimentary indexing means comprises a combination of a recess (28′) and a bushing (68′) with the bushing (68′) inserted or insertable, preferably with interference fit, into the recess (28′).

The indexing means on the second opposing transverse edge (15), for each combination of a complimentary indexing means on the first opposing transverse edge (14′) of the adjacent mould segment (3), comprises a recess (28) and a bushing (68) with the bushing (68) inserted or insertable, preferably with interference fit, into the recess (28). The complimentary indexing means comprises a combination of a recess (18′) and a pin (56′) having a bigger portion (51′) and a smaller portion (52′), with the bigger portion (51′) inserted or insertable, preferably with interference fit, into the recess (18′) and the smaller portion (52′) slidably inserted, preferably with clearance fit, into the opening (65) of the bushing (68).

As described earlier, the bigger portion of the pins (56) is preferably pre-inserted into the recess (18) on the first opposing transverse edge (14) and the bushing (68) is preferably pre-inserted into the recess (28) on the second opposing transverse edge (15). These help the operator loading and setting up the mould segments on a flat press to identify the orientation of the thread pattern so that repeating thread pattern oriented in the same direction for every mould segments of the mould matrix i.e. the first opposing mould walls of every mould segment must be on the same side.

Preferably the length of the bigger portion (51) of the pin (56) is longer than the length of the shorter portion (52) of the pin (56). The length of the bushing (68) and the length of the shorter portion (52) of the pin (56) are substantially equal. Correspondingly, the depth of the recess (18) accommodating the bigger portion (51) of the pin (56) will be longer than the depth of the recess (28) accommodating the bushing (68).

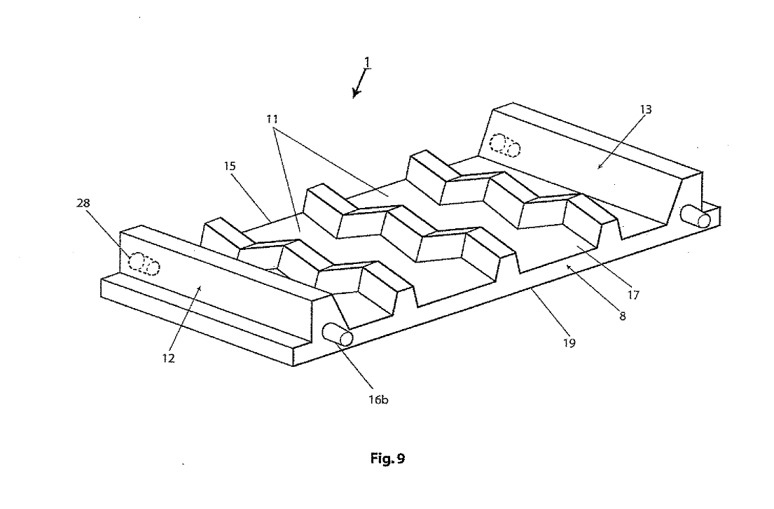

FIG. 8 shows a variation of the embodiment shown in FIG. 7. In this embodiment the indexing means on each of the opposing transverse edge (14 or 15) comprises at least one combination of a recess and a pin (18 and 56 or 28 and 56). The pin (56) has a bigger portion (51) and a smaller portion (52), with the bigger portion (51) inserted or insertable into the recess (18 or 28) and the smaller portion (52) slidably insertable into the opening (65′ or 55′) of the bushing (68′ or 58′ respectively) of a complimentary indexing means on the other opposing transverse edge (15′ or 14′) of an adjacent mould segment (2 or 3) of the mould matrix. The complimentary indexing means comprises a combination of a recess and a bushing (68′ and 28′ or 18′ and 58′) with the bushing (68′ or 58) inserted or insertable into the recess (28′ or 18′) respectively.

FIG. 8 illustrates an embodiment with the combination of a recess, and a pin as indexing means on one opposing transverse edge and a recess and a combination of a bushing as indexing means on the other opposing transverse edge. It is evident from FIG. 8 that two other variations of indexing means could be possible. The first variation is where the indexing means on both opposing transverse edges are a combination of a recess and a pin and the second variation is where the indexing means on both opposing transverse edges are a combination of a recess and a bushing as described below. In the following description, the reference numbers used are consistent with those shown in other drawings.

In the first variation, the indexing means on the first opposing transverse edge (14) of the mould segment (1) comprises at least one combination of a recess (18) and a pin (56). The pin (56) has a bigger portion (51) and a smaller portion (52), with the bigger portion (51) inserted or insertable into the recess (18) and the smaller portion (52) slidably insertable into the opening (65′) of the bushing (68′) of a complimentary indexing means on the second opposing transverse edge (15′) of an adjacent mould segment (2) of the mould matrix. The indexing means on the second opposing transverse edge (15) comprises at least one combination of a recess (28) and a pin (56). The pin (56) has a bigger portion (51) and a smaller portion (52), with the bigger portion (51) inserted or insertable into the recess (28) and the smaller portion (52) slidably insertable into the opening (55′) of the bushing (58′) of a complimentary indexing means on the first opposing transverse edge (14′) of an adjacent mould segment (3) of the mould matrix.

In the second variation, the indexing means on the first opposing transverse edge (14) comprises a recess (18) and a bushing (58) for each combination of a complimentary indexing means on the second transverse edge (15′) of an adjacent mould segment (2). The bushing (58) is inserted or insertable, preferably with interference fit, into the recess (18). The complimentary indexing means on the second transverse edge (15′) of an adjacent mould segment (2) is a pin (56′). The pin (56′) has a bigger portion (51′) and a smaller portion (52′), with the bigger portion (51′) inserted or insertable, preferably with interference fit, into a recess (28′) and the smaller portion slidably insertable into the opening (55) of the bushing (58) on the first opposing transverse edge (14) of the mould segment (I). The indexing means on the second opposing transverse edge (15) comprises a recess (28) and a bushing (68) for each combination of a complimentary indexing means on the first transverse edge (14′) of an adjacent mould segment (2). The bushing (68) is inserted or insertable, preferably with interference fit, into the recess (28). The complimentary indexing means on the first transverse edge (14′) of an adjacent mould segment (3) is a pin (56′). The pin (56′) has a bigger portion (51′) and a smaller portion (52′), with the bigger portion (51′) inserted or insertable, preferably with interference fit, into a recess (18′) and the smaller portion slidably insertable into the opening (65) of the bushing (68) on the second opposing transverse edge (15) of the mould segment (1).

In order to avoid mix up in the orientation of the thread pattern during the set up of the mould matrix in a flat press, for both when the indexing means comprises a combination of a recess (18 or 28) and a bushing (58 or 68), and when the indexing means comprises a combination of a recess (18 or 28) and a pin (56), it is preferable that the distance between any two recesses (18) on the first opposing transverse edge (14) be different from the distance between any two recesses (28) on the second opposing transverse edge (15). Further it is preferable that the bigger portion (51) of the pin (56) and the bushing (58) be pre-inserted into the respective recesses (18, 28).

For both embodiments illustrated in FIGS. 7 and 8, including the variations to the embodiments illustrated in FIG. 8 as described earlier, the cross-sectional profile of the recess (18 or 28), the bushing (58 or 68) and the bigger portion (51) of the pin (56) should be the same. Similarly, the cross-sectional profile of the opening (55) of the bushing (58), the opening (65) of the bushing (68) and the smaller portion (52) of the pin (56) should be the same to enable the smaller portion (52) of the pin (56) to be insertable into the opening (55 or 65) of the bushing (58 or 68). Preferably, for ease of manufacturing in a machining operation and pre-moulding set up on the flat press, the recess (18, 28) and the smaller (52) and bigger portions (51) of the pin (56) are preferably cylindrical in shape and the bushings (58, 68) are preferably cylindrical tubular in shape.

For both embodiments illustrated in FIGS. 7 and 8, the smaller portion (52) of the pin (56) is preferably beveled, chamfered or having a conical frustum shape at the end distal from the bigger portion (51) to facilitate the insertion of the smaller portion (52) of the pin (56) into the opening (55 or 65) of the bushing (58 or 68) in the loading and setting up of the mould matrix on a flat press.

For both embodiments illustrated in FIGS. 7 and 8, preferably the bushings (58, 68) and/or the bigger portion (51) of the pin (56) are inserted with interference fit into the respective recesses (18, 28) of the mould segment (1).

In all the embodiments above, preferably the recesses (18, 28) are located on that part of the opposing transverse edges (14 and 15) making up part of the first or the second opposing mould walls (12 or 13) of the mould segment.

In all the embodiments above, preferably the pin (16 or 56) and the bushings (58 or 68) are made of a material harder than the material used in the manufacture of the mould segment (1).

FIG. 9 shows yet another embodiment of the mould segment (1) of this invention wherein the indexing means on each of the first opposing and second transverse edges (14 and 15) of the mould segment (1) comprises at least one protrusion (16b) and/or at least one recess (18). When the indexing means on the opposing transverse edge (14 or 15) is a protrusion (16b), the complimentary indexing means on a substantially identical mould segment (2 or 3) placed adjacent to the mould segment (1) of a mould matrix is a recess (28′ or 18′) on the other opposing transverse edge (15′ or 14′) of the adjacent mould segment (2 or 3), with protrusion (16b) slidably insertable into the recess (28′ or 18′). When the indexing means on the opposing transverse edge (14 or 15) is a recess (18 or 28), the complimentary indexing means on a substantially identical mould segment (2 or 3) placed adjacent to the mould segment (1) of the mould matrix is a protrusion (16b′) on the other opposing edge (15′ or 14′) of the adjacent mould segment (2 or 3), with the protrusion (16b′) slidably insertable into the recess (18 or 28). In this embodiment the or each of the protrusions (16b) is an integral part of the mould segment (1).

In all the embodiments above, the opposing transverse edge (15′) and the centre point of the recess (28′) are mirror images of the opposing transverse edge (14) and the recess (18) respectively. Similarly, the opposing transverse edge (14′) and the centre point of the recess (18′) are mirror images of the opposing transverse edge (15) and the recess (28) respectively.

The invention also relates to a method of aligning mould segments in a mould matrix using indexing means on the opposing transverse edges of the mould segments. When the indexing means for one opposing transverse edge (14 or 15) is a male part, the corresponding complementary indexing means for the other opposing transverse edge (15′ or 14′) on the adjacent mould segment will be a female part and vice versa. The male part could be a combination of a recess (18) and a pin (16) (FIG. 4) or a combination of a recess (18), a bushing (58) and a pin 16a (FIG. 6) or a combination of a recess (18) and a pin (56) (FIG. 7). The corresponding female part would be a recess (28′) (FIG. 4) or a combination of a recess (28′) and a bushing (65′) (FIG. 6) or a combination of a recess (28′) and a bushing (65′) (FIG. 6) respectively.

The invention being thus described, it will be obvious that the same may be varied in many ways. Such variations are not to be regarded as a departure from the principle and scope of the invention, and all such modifications as would obvious to one skilled in the art intended to be included within the scope of following claims.

1. A mould segment (1) of a mould matrix used in the production of premoulded and precured tyre thread, the mould segment (1) comprising:
a base (8) with a base back (19), a base front (17) and transverse edges forming part of the first and second opposing transverse edges (14 and 15) of the mould segment (1);
a first and a second opposing mould walls (12, 13) at each end of the base (8) and rising from the base front (17), each opposing mould walls (12, 13) having an inner surface (21), an outer surface (22), a contact surface (23), a shoulder (24) and transverse edges forming part of the first and second transverse edges (14 and 15) of the mould segment (1);
a mould cavity (11) on the base front (17) and between the opposing mould walls (12, 13) with the mould cavity (11), the opposing mould walls (12, 13) and the base (8) forming an integral unit;
wherein the mould segment (1) is provided with an indexing means for the first and second opposing transverse edges (14 and 15) for alignment of the mould segment (1) to the adjacent mount segments (2 and 3) of the mould matrix.

2. A mould segment (1) of a mould matrix used in the production of premoulded and precured tyre thread as in claim 1,
wherein the indexing means for the first opposing transverse edge (14) comprises at least one combination of:
a recess (18) on the first opposing transverse edge (14) and
a pin (16), the pin (16) having a portion inserted or insertable into the recess (18) and with the remaining portion slidably insertable into a recess (28′) on the second opposing transverse edge (15′) of an adjacent mould segment (2) of the mould matrix, the recess (28′) being the complimentary indexing means on the opposing transverse edge (15′) and wherein the opposing transverse edge (15′) and the centre point of the recess (28′) being mirror images of the opposing transverse edge (14) and the centre point of the recess (18) respectively, and
wherein the indexing means on the second opposing transverse edge (15) comprises a recess (28) for each combination of complimentary indexing means on the first opposing transverse edge (14′) of an adjacent mould segment (3), the complimentary indexing means comprises a combination of a recess (18′) on the first opposing transverse edge (14′) of the adjacent mould segment (3) and a pin (16′) with a portion inserted or insertable into the recess (18′) and with the remaining portion slidably insertable into the recess (28).

3. A mould segment (1) of a mould matrix used in the production of premoulded and precured tyre thread as in claim 2, wherein each recess (18 or 28) and the pin (16) are cylindrical in shape.

4. A mould segment (1) of a mould matrix used in the production of premoulded and precured tyre thread as in claim 1,
wherein the indexing means on the first opposing transverse edge (14) comprises at least one combination of:
a recess (18) on the first opposing transverse edge (14),
a bushing (58), the bushing (58) inserted or insertable into the recess (18), and
a pin (16a) with a portion inserted or insertable into the opening (55) of the bushing (58) and with the remaining portion slidingly insertable into the opening (65′) of the bushing (68′) of a complimentary indexing means on the second opposing transverse edge (15′) of an adjacent mould segment (2) of the mould matrix, the complimentary indexing means comprises a recess (28′) and a bushing (68′), the bushing (68′) being inserted or insertable into the recess (28′), and wherein the opposing transverse edge (15′) and the centre point of the recess (28′) being mirror images of the opposing transverse edge (14) and the centre point of the recess (18) of mould segment (1) respectively, and
wherein the indexing means on the second opposing transverse edge (15), for each combination of a complimentary indexing means on the first opposing transverse edge (14′) of the adjacent mould segment (3), comprises:
a recess (28) on the second opposing transverse edge (15), and
a bushing (68), the bushing (68) inserted or insertable into the recess (28),
wherein the complimentary indexing means comprises a combination of a recess (18′) and a bushing (58′) inserted or insertable into the recess (18′) and a pin (16a′) with a portion inserted or insertable into the opening (55′) of the bushing (58′) with the remaining portion slidably insertable into the opening (65) of the bushing (68).

5. A mould segment (1) of a mould matrix used in the production of premoulded and precured tyre thread as in claim 4 wherein the recess (18) on the first opposing transverse edge (14) is deeper than the recess (28) on the second opposing transverse edge (15).

6. A mould segment (1) of a mould matrix used in the production of premoulded and precured tyre thread as in claim 1,
wherein the indexing means on the first opposing transverse edge (14) comprises at least one combination of:
a recess (18), and
a pin (56), the pin (56) having a bigger portion (51) and a smaller portion (52), with the bigger portion (51) inserted or insertable into the recess (18) and the smaller portion (52) slidably insertable into the opening (65′) of the bushing (68′) of a complimentary indexing means on the second opposing transverse edge (15′) of an adjacent mould segment (2), the complimentary indexing means comprising a combination of a recess (28′) and a bushing (68′) with the bushing (68′) inserted or insertable into the recess (28′) and wherein the opposing transverse edge (15′) and the centre point of the recess (28′) being mirror image of the 25 opposing transverse edge (14) and the centre point of the recess (18) respectively, and
wherein the indexing means on the second opposing transverse edge (15), for each combination of a complimentary indexing means on the first opposing transverse edge (14′) of the adjacent mould segment (3), comprises:
recess (28), and
a bushing (68), the bushing (68) inserted or insertable into the recess (28),
wherein the complimentary indexing means comprises a combination of a recess (18′) and a pin (56′) having a bigger portion (51′) and a smaller portion (52′), with the bigger portion (51′) inserted or insertable into the recess (18′) and the smaller portion (52′) slidably inserted into the opening (65) of the bushing (68).

7. A mould segment (1) of a mould matrix used in the production of premoulded and precured tyre thread as in claim 6, wherein the bigger portion (51) of the pin (56) is suitably dimensioned such that the pin (56) may be inserted into the recess (18) with interference fit and the smaller portion (52) of the pin (56) is suitably dimensioned for slidably insertable with clearance fit into the opening (55) of the bushing (58).

8. A mould segment (1) of a mould matrix used in the production of premoulded and precured tyre thread as in claim 6 or 7, wherein the recess (18 or 28), the bigger and smaller portions (51, 52) of the pin (56) are cylindrical in shape and wherein the bushing (68) is cylindrical tubular in shape.

9. A mould segment (1) of a mould matrix used in the production of premoulded and precured tyre thread as in claim 8, wherein the smaller portion (52) of the pin (56) is beveled or chamfered or conical frustum in shape at the distal end to the bigger portion (51).

10. A mould segment (1) of a mould matrix used in the production of premoulded and precured tyre thread as in claim 6 wherein the length of the bigger portion (51) of the pin (56) is longer than the length of the shorter portion (52) of the pin (56).

11. A mould segment (1) of a mould matrix used in the production of premoulded and precured tyre thread as in claim 6 wherein the length of the bushing (68) inserted into the recess (28) and the length of the shorter portion (52) of the pin (56) are substantially equal to the depth of the recess (28).

12. A mould segment (1) of a mould matrix used in the production of premoulded and precured tyre thread as in claim 1,
wherein the indexing means on the first opposing transverse edge (14) comprises at least one combination of a recess (18) and a pin (56), the pin (56) having a bigger portion (51) and a smaller portion (52), with the bigger portion (51) inserted or insertable into the recess (18) and the smaller portion (52) slidably insertable into the opening (65′) of the bushing (68′) of a complimentary indexing means on the second opposing transverse edge (15′) of an adjacent mould segment (2) of the mould matrix, the opposing transverse edge (15′) and the recess (28′) being mirror images of the opposing transverse edge (14) and the recess (18) respectively, and
wherein the indexing means on the second opposing transverse edge (15) comprises at least one combination of a recess (28) and a pin (56), the pin (56) having a bigger portion (51) and a smaller portion (52), with the bigger portion (51) inserted or insertable into the recess (28) and the smaller portion (52) slidably insertable into the opening (55′) of the bushing (58′) of a complimentary indexing means on the first opposing transverse edge (14′) of an adjacent mould segment (3) of the mould matrix, the opposing transverse edge (14′) and the recess (18′) being mirror images of the opposing transverse edge (14) and the recess (18) respectively.

13. A mould segment (1) of a mould matrix used in the production of premoulded and precured tyre thread as in claim 1,
wherein the indexing means on the first opposing transverse edge (14), for each combination of a complimentary indexing means on the second transverse edge (15′) of an adjacent mould segment (2), comprises a recess (18) and a bushing (58) with the bushing (58) inserted or insertable into the recess (18), and wherein the complimentary indexing means comprises a combination of a recess (28′) on the second transverse edge (15′) of the adjacent mould segment (2) and a pin (56′), the pin (56′) having a bigger portion (51) and a smaller portion (52′), with the bigger portion (51′) inserted or insertable into a recess (28′) and the smaller portion slidably insertable into the opening (55) of the bushing (58), the opposing transverse edge (15′) and the centre point of the recess (28′) being mirror images of the opposing transverse edge (14) and the recess (18) respectively, and
wherein the indexing means on the second opposing transverse edge (15), for each combination of a complimentary indexing means on the first transverse edge (14′) of an adjacent mould segment (2), comprises a recess (28) and a bushing (68) with the bushing (68) inserted or insertable into the recess (28), and wherein the complimentary indexing means comprises a combination of a recess (18′) on the first transverse edge (14′) of adjacent mould segment (3) and a pin (56′), the pin (56′) having a bigger portion (51′) and a smaller portion (52′), with the bigger portion (51′) inserted or insertable into a recess (18′) and the smaller portion slidably insertable into the opening (65) of the bushing (68), the opposing transverse edge (14′) and the centre point of the recess (18′) being mirror images of the opposing transverse edge (15) and the recess (28) respectively.

14. A mould segment (1) of a mould matrix used in the production of premoulded and precured tyre thread as in claim 1,
wherein the indexing means on each of the first opposing and second transverse edges (14 and 15) of the mould segment (1) comprises at least one protrusion (16b) and/or at least one recess (18),
wherein when the indexing means is a protrusion (16b) on the opposing transverse edge (14 or 15), the complimentary indexing means on a substantially identical mould segment (2 or 3) placed adjacent to the mould segment (1) of a mould matrix is a recess (28′ or 18′) on the other opposing transverse edge (15′ or 14′) of the adjacent mould segment (2 or 3), with protrusion (16b) slidably insertable into the recess (28′ 18′) the opposing transverse edge (15′ or 14′) and the centre point of the recess (28′ or 18′) being mirror images of the opposing transverse edge (14 or 15) and the centre point of the recess (18 or 28) respectively, and
wherein when the indexing means is a recess (18 or 28) on the opposing transverse edge (14 or 15), the complimentary indexing means on a substantially identical mould segment (2 or 3) placed adjacent to the mould segment (1) of the mould matrix is a protrusion (16b′) on the other opposing edge (15′ or 14′) of the adjacent mould segment (2 or 3), with the protrusion (16b′) slidably insertable into the recess (18 or 28), the opposing transverse edge (15′ or 14′) and the centre point of the recess (28′ or 18′) being mirror images of the opposing transverse edge (14 or 15) and the recess (18 or 28) respectively, and
wherein the protrusion (16b) is an integral part of the mould segment (1).

15. A mould segment (1) of a mould matrix used in the production of premoulded and precured tyre thread as in claim 4 wherein the pin (16 or 56) is made of a material harder than the material used in the manufacture of the mould segment (1).

16. A mould segment (1) of a mould matrix used in the production of premoulded and precured tyre thread as in claim 4 wherein the bushing (58 or 68) is made of a material harder than the material used in the manufacture of the mould segment (1).

17. A mould segment (1) of a mould matrix used in the production of premoulded and precured tyre thread as in claim 2 wherein the recess (18 or 28) is located on that part of the opposing transverse edge (14 or 15) making up part of either the first or the second opposing mould walls (12 or 13) of the mould segment.

18. A method of aligning mould segments in a mould matrix comprising the provision of indexing means on the opposing transverse edges (14, 15) of the mould segment.
